(19) United States
(12) Patent Application Publication
(10) Pub. No.: US 2018/0205075 A1
(43) Pub. Date: Jul. 19, 2018

(54) PRODUCTION METHOD FOR GRAPHITE-CONTAINING CARBON POWDER FOR SECONDARY BATTERY, AND CARBON MATERIAL FOR BATTERY ELECTRODE

(71) Applicant: SHOWA DENKO K. K., Tokyo (JP)

(72) Inventors: Yasuaki WAKIZAKA, Tokyo (JP); Yoshikuni SATO, Tokyo (JP); Daisuke MIYAMOTO, Tokyo (JP)

(73) Assignee: SHOWA DENKO K. K., Tokyo (JP)

(21) Appl. No.: 15/743,906

(22) PCT Filed: Jul. 12, 2016
(86) PCT No.: PCT/JP2016/070526

§ 371 Date: Jan. 11, 2018

(30) Foreign Application Priority Data
Jul. 16, 2015 (JP) 2015-142130

(51) Int. Cl. H01M 4/36; H01M 4/587; H01M 10/0525; H01M 4/58

(52) U.S. Cl. CPC H01M 4/366; H01M 4/587; H01M 2004/027; H01M 4/58; H01M 2220/20; H01M 10/0525

(57) ABSTRACT

The present invention relates to a method for producing a graphite-containing carbon powder for a negative electrode of a lithium ion secondary battery having a high undersize yield and a high tapping density, which does not need pulverization treatment after heat treatment. The method comprises a process of forming a carbon coating on the surface of the carbide particles to obtain a carbon-coated raw material; a process of mixing the carbon-coated raw material and a carbon material to obtain a mixed raw material; and a heat treatment process of heating the mixed raw material to 2,000° C. or more to thermally decompose the carbide. Using the graphite-containing carbon powder according to the method of the present invention makes it possible to efficiently obtain a carbon material for a battery electrode, an electrode comprising the carbon material, and a secondary battery having the electrode.

### TECHNICAL FIELD

The present invention relates to a method for producing a graphite-containing carbon powder for use in an electrode (preferably a negative electrode) of a secondary battery such as a lithium ion secondary battery, and a carbon material for a battery electrode containing the graphite-containing powder. Specifically, the present invention relates to a graphite-containing carbon powder for use in an electrode (a negative electrode) which enables production of a lithium ion secondary battery having a high capacity, a high density and a high capacity retention rate at low cost; a method for producing the same; and a carbon material for a secondary battery electrode (negative electrode) containing the carbon powder.

### BACKGROUND ART

As a power source of a mobile device, or the like, a lithium ion secondary battery is mainly used. In recent years, the function of the mobile device or the like is diversified, resulting in increasing in power consumption thereof. Therefore, a lithium ion secondary battery is required to have an increased battery capacity and, simultaneously, to have an enhanced charge/discharge cycle characteristic.

Further, there is an increasing demand for a secondary battery with a high power and a large capacity for use in electric tools such as an electric drill and a hybrid automobile. In this field, conventionally, a lead secondary battery, a nickel-cadmium secondary battery, and a nickel-hydrogen secondary battery are mainly used. A small and light lithium ion secondary battery with high energy density is highly expected, and there is a demand for a lithium ion secondary battery excellent in large current load characteristics.

In particular, in applications for automobiles, such as battery electric vehicles (BEV) and hybrid electric vehicles (HEV), a long-term cycle characteristic over 10 years and a large current load characteristic for driving a high-power motor are mainly required, and a high volume energy density is also required for extending a cruising distance, which are severe as compared to mobile applications.

In the lithium ion secondary battery, generally, a lithium salt, such as lithium cobaltate, is used as a positive electrode active material, and a carbonaceous material, such as graphite, is used as a negative electrode active material.

Graphite is classified into natural graphite and artificial graphite. Among those, natural graphite is available at a low cost and has a high discharge capacity due to its high crystallinity. However, as natural graphite has a scale-like shape, if natural graphite is formed into a paste together with a binder and applied to a current collector, natural graphite is aligned in one direction. When a secondary battery provided with an electrode using natural graphite of high orientation property as a carbonaceous material is charged, the electrode expands only in one direction, which degrades the performance of the battery. The swelling of the electrode leads to the swelling of the battery, which may cause cracks in the negative electrode due to the swelling or may damage the substrates adjacent to the battery due to the detachment of a paste from the current collector. This has been an issue to be solved. Natural graphite, which has been granulated and formed into a spherical shape, is proposed, however, the spherodized natural graphite is crushed to be aligned by pressure applied in the course of electrode production. Further, as the spherodized natural graphite expands and contracts, the electrolyte intrudes inside the particles of the natural graphite to cause a side reaction. Therefore, the electrode material made of such natural graphite is inferior in cycle characteristics, and it is very difficult for the material to satisfy the requests such as a large current and a long-term cycle characteristic of a large battery. In order to solve those problems, Japanese Patent No. 3534391 (Patent Document 1) proposes a method involving coating carbon on the surface of the natural graphite processed into a spherical shape. However, the material according to the method described in the Patent Document 1 can address the issues related to a high capacity, a low current, and a medium-term cycle characteristics required for use in mobile devices but it is very difficult for the material to satisfy the requirement for a large-size battery such as a large current and an ultra-long term cycle characteristics.

Regarding artificial graphite, there is exemplified a mesocarbon microsphere-graphitized article described in JP H04-190555 A (Patent Document 2) and the like. However, the article has a lower discharge capacity compared to a scale-like graphite and had a limited range of application. In the case of using a graphitized article obtained by this method, it is difficult to achieve the cycle characteristic for a much longer period of time than the one for mobile applications, which is required for a large battery.

Artificial graphite typified by graphitized articles of petroleum, coal pitch, coke and the like is available at a relatively low cost. However, although a graphitized article of needle-shaped coke of high crystallinity shows a high discharge capacity, it is formed into a scale-like shape and is easy to be oriented in an electrode. In order to solve this problem, the method described in Japanese Patent No. 3361510 (Patent Document 3) has shown successful results. The method can allow the use of not only fine powder of an artificial graphite raw material but also fine powder of a natural graphite or the like, and exhibits very excellent performance for a negative electrode material for the mobile applications. However, its production method is cumbersome.

Further, negative electrode materials using so-called hard carbon and amorphous carbon described in JP H07-320740 A (U.S. Pat. No. 5,587,255; Patent Document 4) are excellent in a characteristic with respect to a large current and also have a relatively satisfactory cycle characteristic. However, the volume energy density of the negative electrode material is too low and the price of the material is very expensive, and thus, such negative electrode materials are only used for some special large batteries.

Japanese Patent No. 4738553 (U.S. Pat. No. 8,372,373; Patent Document 5) discloses artificial graphite being excellent in cycle characteristics but there was room for improvement on the energy density per volume.

JP 2001-23638 A (Patent Document 6) discloses an artificial graphite negative electrode produced from needle-shaped green coke. Although the electrode showed some improvement in an initial charge and discharge efficiency compared to an electrode of conventional artificial graphite, it was inferior in a discharge capacity compared to an electrode of a natural graphite material.

JP 2005-515957 A (U.S. Pat. No. 9,096,473; Patent Document 7) discloses an artificial graphite negative electrode produced from cokes coated with petroleum pitch in a liquid phase. In the negative electrode, the electrode capacity density has remained as an issue to be solved. Also, the production involves an operation of using large quantities of organic solvent and evaporating it, which makes the production method cumbersome.

JP H09-157022 A (CA 2,192,429; Patent Document 8) discloses a method of obtaining a high-purity graphite by subjecting silicon carbide as an initial material to high-temperature treatment and thermally dissociating silicon atoms. The document teaches that the obtained graphite can attain an inter-crystallite distance roughly equivalent to that of natural graphite and crystal axes are not oriented. Therefore, it is suggested that a battery using such graphite as a negative electrode has a high discharge capacity and high cycle characteristics. However, a pulverization process is needed since the graphite obtained by the method is produced in aggregates, and the production method is cumbersome. In addition, the pulverization process is accompanied by generation of lattice defects, and lithium ions irreversibly bond thereto. As a result, a negative electrode using a graphite powder that has undergone a pulverization process has a problem of decrease in cycle characteristics.

### PRIOR ART

### Patent Documents

Patent Document 1: JP 3534391 B2

Patent Document 2: JP 04-190555 A

Patent Document 3: JP 3361510 B2

Patent Document 4: JP 07-320740 A (U.S. Pat. No. 5,587,255)

Patent Document 5: Japanese Patent No. 4738553 (U.S. Pat. No. 8,372,373)

Patent Document 6: JP 2001-023638 A

Patent Document 7: JP 2005-515957 A (U.S. Pat. No. 9,096,473)

Patent Document 8: JP H09-157022 A (CA 2,192,429)

### DISCLOSURE OF THE INVENTION

### Problems to be Solved by the Invention

An object of the present invention is to provide a method for producing a graphite-containing carbon powder for a negative electrode material in a lithium ion secondary battery having a high undersize yield and a high tapping density, which does not need pulverization treatment after heat treatment.

### Means to Solve the Problem

As a result of intensive studies, the present inventors have found that the problems can be solved by conducting coating treatment of the surface of the carbide used as a raw material with a carbon coating material, and then subjecting the carbide coated with a carbon coating material to heat treatment. Based on the finding, the present inventors have accomplished the present invention regarding a method for producing a graphite-containing carbon powder for a negative electrode of a lithium ion secondary battery having a high tapping density, which does not need pulverization treatment after heat treatment.

That is, the present invention comprises the structures as below.

[1] A method for producing a graphite-containing carbon powder for an electrode of a lithium ion secondary battery, comprising a process of forming a carbon coating on the surface of the carbide particles to obtain a carbon-coated raw material; a process of mixing the carbon-coated raw material and a carbon material to obtain a mixed raw material; and a heat treatment process of heating the mixed raw material to 2,000° C. or more to thermally decompose the carbide.
[2] The method for producing a graphite-containing carbon powder for an electrode of a lithium ion secondary battery according to [1] above, wherein the carbide contains at least one member selected from silicon carbide, iron carbide, tungsten carbide, calcium carbide, aluminum carbide, molybdenum carbide, beryllium carbide, and nickel carbide.
[3] The method for producing a graphite-containing carbon powder for an electrode of a lithium ion secondary battery according to [1] or [2] above, wherein the carbon coating comprises pitch or a polymer compound.
[4] The method for producing a graphite-containing carbon powder for an electrode of a lithium ion secondary battery according to any one of [1] to [3] above, wherein the carbon material is easily-graphitizable carbon.
[5] The method for producing a graphite-containing carbon powder for an electrode of a lithium ion secondary battery according to any one of [1] to [4] above, wherein the easily-graphitizable carbon contains at least one member of coke and coal.
[6] The method for producing a graphite-containing carbon powder for an electrode of a lithium ion secondary battery according to any one of [1] to [5] above, wherein a carbon coating content in the carbon-coated raw material is 0.5 part by mass to 20.0 parts by mass with respect to 100 parts by mass of the carbide particles.
[7] The method for producing a graphite-containing carbon powder for an electrode of a lithium ion secondary battery according to any one of [1] to [6] above, wherein the carbon-coated raw material and the carbon material are mixed so that the content of the carbon-coated raw material with respect to the mixed raw material obtained by mixing the carbon-coated raw material and the carbon material (mass of the carbon-coated raw material/total of the mass of the carbon-coated raw material and the mass of the carbon material) is 1.0 to 40.0 mass %.
[8] A method for producing a graphite-containing carbon powder for an electrode of a lithium ion secondary battery, comprising a process of forming a carbon coating on the surface of the carbide particles to obtain a carbon-coated raw material; and a heat treatment process of heating the carbon-coated raw material to 2,000° C. or more to thermally decompose the carbide.
[9] A carbon material for a battery electrode containing the graphite-containing carbon powder obtained by the production method according to any one of [1] to [8] above.
[10] The carbon material for a battery electrode according to [9] above, further comprising at least one member selected from natural graphite, artificial graphite and carbon fiber.
[11] An electrode containing the carbon material for a battery electrode according to [9] or [10] above which serves as at least part of an electrode active material.
[12] A secondary battery comprising an electrode according to [11] above.

### Effects of the Invention

The production method of the present invention can provide a graphite-containing carbon powder for a negative electrode of a lithium ion secondary battery which has a higher undersize yield and a higher tapping density compared to a carbon powder obtained by a conventional technology.

### EMBODIMENTS FOR CARRYING OUT THE INVENTION

(1) Method for Producing a Graphite-Containing Carbon Powder for a Negative Electrode for a Lithium Ion Secondary Battery

The graphite-containing carbon powder in an embodiment of the present invention can be obtained by coating particles of a carbide of an element other than carbon with a carbon coating material, mixing the carbide particles coated with a carbon coating material (hereinafter may be referred to as “carbon-coated raw material”) with a carbon material, and subjecting the mixture to heat treatment. Materials, dimensions, and the like given in the following description are examples, and the present invention is not limited thereto and may be carried out while being appropriately changed to the extent that the gist thereof is not changed. When a carbon material is not used, a process of mixing can be skipped and the carbide particles coated with a carbon coating material may be directly subjected to heat treatment. In the present description, carbon powders including these mixtures obtained by the production method of the present invention are collectively referred to as a “graphite-containing carbon powder”.

As carbide used as a raw material, any kind of carbides can be used as long as it is solid at ordinary temperature. For example, a compound capable of generating graphite by heat treatment, such as silicon carbide, iron carbide, tungsten carbide, calcium carbide, aluminum carbide, molybdenum carbide, beryllium carbide and nickel carbide, can be used.

When silicon carbide is used as a raw material, the kind of silicon carbide is not particularly limited, and the one produced by a usual method such as a method of mixing a carbon material and a silicon raw material and using a heating device such as Acheson furnace, or a gas phase method can be used. The silicon carbide to be used is preferably a high-purity silicon carbide. Heating high-purity silicon carbide to thereby evaporate silicon enables production of high-purity graphite.

The method of producing a graphite-containing carbon powder of the present invention can be applied to any particle size distribution. However, when the graphite-containing carbon powder obtained by the method of the present invention is used as a negative electrode active material of a lithium ion secondary battery, it is desirable that the carbon powder has such a particle size distribution that allows the carbon powder to effectively operate as an active material. Therefore, there is an optimal range of the particle size distribution for the carbide particles serving as a raw material. Carbide particles having an optimal range of the particle size distribution can be obtained by, for example, pulverization, classification, or a combination thereof.

There is no limitation for the pulverization method to pulverize carbide to make it into carbide particles, and it can be conducted using a known jaw crusher, roller mill, jet mill, hammer mill, roller mill, pin mill, vibration mill or the like.

It is desirable to perform pulverization so that carbide particle has a 50% particle diameter in a volume-based cumulative particle size distribution by laser diffraction method, D₅₀ (median diameter), of from 1 μm to 50 μm. By performing pulverization to make D₅₀ less than 50 μm, the particle diameter of the obtained graphite powder can be reduced. However, it requires use of a specific equipment and a large amount of energy to make D₅₀ less than 1 μm. D₅₀ is more preferably from 5 μm to 35 μm, still more preferably from 10 μm to 25 μm.

The method for producing the graphite-containing powder of the present invention comprises a process of producing a carbon-coated raw material by forming a carbon coating on a part or entirety of the surface of carbide particles serving as a raw material. A specific method of forming a carbon coating is not particularly limited. For example, the carbon coating can be formed by a chemical vapor deposition (CVD) method, a wet method, a dry method or the like.

By forming a carbon coating on the surface of carbide particles, fusion of the carbide particles can be prevented in the subsequent heat treatment process. Prevention of fusion can prevent coarsening of the graphite particles generated by the thermal decomposition of the carbide particles after heat treatment, which allows control of the particle size distribution. In addition, by forming a carbon coating, the shape of the graphite particles can be controlled and a particle structure becomes dense. In the method of producing a graphite-containing carbon powder of the present invention, by preventing coarsening of the carbide particles, the graphite-containing carbon powder obtained by heat treatment can have an optimal particle size distribution as a negative electrode active material for a secondary battery, and have a high tapping density due to the dense particles.

A carbon coating is formed on part or entirety of the surface of the carbide particles. From the viewpoint of preventing fusion of carbide particles and from the viewpoint of making the particle structure dense, a higher coverage of the carbon coating on the surface of the carbide particles increases the effect, and the thicker carbon coating increases the effect. However, when the carbon coating is too thick, the electrode density becomes difficult to increase at the time of pressing during the production of an electrode using the produced graphite-containing carbon powder, and the energy density of the secondary battery becomes difficult to increase. Therefore, in the carbon-coated raw material, the content of the carbon coating is preferably 0.5 part by mass to 20.0 parts by mass, more preferably 1.0 part by mass to 10.0 parts by mass with respect to 100 parts by mass of the carbide particle content.

When a CVD method is used for forming a carbon coating, a carbon coating can be formed on the surface of the carbide particles by spraying a gas of a carbon compound at a high temperature of 700° C. or more. Since a carbon coating is generated by thermally decomposing a gas of a carbon compound on the surface of the carbide particles, a uniform coating film can be easily obtained. As a gas of a carbon compound, an arbitrary hydrocarbon gas such as benzene, toluene, ethylene, acetylene, methane and ethane can be used. In order to form a uniform carbon coating, it is desirable to inject a gas of a carbon compound into the carbide particles in a fluidized state by using a fluidized-bed gasifier.

When a carbon coating is formed by a wet method, the methods include, for example, a method of dissolving or dispersing a carbon coating material such as pitch and a polymer compound in a liquid, further adding carbide particles thereto, and then removing a solution or a dispersion by drying. Or, a method of melting a carbon coating material by heating and mixing the melted carbon coating material with carbide particles can be employed. For the purpose of preventing the fusion of the particles in the subsequent heat treatment process more efficiently, the carbide particles having a carbon coating formed thereon may be sintered prior to the heat treatment process. The sintering temperature is 700° C. or more, and a device such as a rotary kiln and a roller hearth kiln can be used. The sintering atmosphere is preferably an inert gas atmosphere without containing oxygen, and it is desirable to perform sintering, for example, under a nitrogen gas atmosphere. When the carbide particles have been bound and coarsened after drying or sintering, pulverization can be performed to obtain a carbon coating material in a powder form. When an organic solvent is used, an organic solvent requires careful handling. Furthermore, the prevention of generation or the collection of the vapor of the organic solvent is needed. Therefore, it is desirable to form a carbon coating by a dry method free from an organic solvent.

When a carbon coating is formed by a dry method, examples of the methods includes a method of dry blending carbide particles and pulverized particles of the carbon coating material. In this case, it is desirable to perform the mixing with a certain force that will hardly pulverize the carbide particles. For mixing, it is desirable to use, in addition to a dry particle composing machine such as NOBILTA (trademark) manufactured by Hosokawa Micron Corporation and a mixer having a small pulverizing power such as a planetary and centrifugal mixer and a Henschel mixer, a mixer with a detuned pulverization performance by controlling the liner part, blades and number of rotations of a hammer mill, a impeller mill and the like. Among these, a hammer mill and an impeller mill have a weak pulverizing power but a high mixing power and suitable for performing a dry-method coating continuously in a short time. For the purpose of more effectively preventing fusion of particles in the subsequent heat treatment process, the carbide particles having a carbon coating formed thereon may be sintered prior to the heat treatment process. The sintering temperature is 700° C. or more, and a device such as a rotary kiln and a roller hearth kiln can be used. The sintering atmosphere is preferably an inert gas atmosphere without containing oxygen, and it is desirable to perform sintering, for example, under a nitrogen gas atmosphere. When the carbide particles have been bound and coarsened after drying or sintering, pulverization can be performed to obtain a carbon coating material in a powder form.

As a carbon coating material, pitch mainly comprising carbon, a polymer compound, and the like can be used. As pitch, for example, petroleum pitch, coal pitch and the like can be used. As a polymer compound, thermosetting resin such as phenol resin can be used. Especially when a dry method treatment is employed, it is desirable to use the particles obtained by finely pulverizing the coating material such as petroleum pitch, coal pitch and phenol resin. When finely pulverizing the coating material, it is desirable to perform pulverization so that the median particle diameter based on a volume by the laser diffraction method, D₅₀, of the coating material is less than D₅₀ of the carbide particles and falls within a range of from 0.01 μm to 25 μm. Making the particle diameter of the coating material excessively small not only causes the agglomeration of particles but also could cause dust explosion. D50 is more preferably 0.5 μm or more and still more preferably 1.0 μm or more. To make the formed film more uniform and denser, D₅₀ is preferably 10 μm or less and more preferably 5 μm or less.

The method for producing the graphite-containing carbon powder of the present invention comprises a process of mixing the carbon-coated raw material and a carbon material that serves as a fusion inhibitor prior to the heat treatment process to obtain a mixed raw material, in order to increase the effect of preventing fusion of the carbide particles at the time of heat treatment.

By forming a carbon coating on the surface of carbide particles to thereby obtain a carbon-coated raw material, fusion of the carbide particles can be prevented in the heat treatment process. By further adding a carbon material, further effect of preventing fusion can be expected in some cases. When the added carbon material is easily-graphitizable carbon, the carbon material is graphitized at the same time with the carbide particles by heat treatment.

In addition, since the properties of the carbon material to be mixed can be freely selected, it is possible to control the properties of the graphite-containing carbon powder obtained by the production method of the present invention. The content of the carbon-coated raw material with respect to the mixed raw material obtained by mixing the carbon-coated raw material and the carbon material (mass of the carbon-coated raw material/total of the mass of the carbon-coated raw material and the mass of the carbon material) is preferably 1.0 to 40.0 mass %. When the content of the carbon-coated raw material is too low, the amount of graphite derived from the carbide decreases in the carbon-containing carbon powder obtained by one heat treatment. When the content of the carbon-coated raw material is too high, it will promote the fusion of the carbide particles, and the yield of the graphite powder having a desired particle size decreases. From this viewpoint, the content of the carbon-coated raw material is more preferably 5.0 to 30.0 mass %, still more preferably 10.0 to 20.0 mass %.

There is no particular limitation for a carbon material to be mixed. For example, coke, coal, phenol resin, pitch or the like can be used. When easily-graphitizable carbon such as coke is used, a mixture of high purity decomposed graphite generated from a carbide, and soft carbon or artificial graphite generated from a carbon material can be obtained by heat treatment. Or, when hardly-graphitizable carbon such as phenol resin is used, a mixture of decomposed graphite generated from a carbide and a hard carbon generated from a carbon material can be obtained.

Since a carbide and a carbon material are simultaneously graphitized at the time of heat treatment, the obtained graphite-containing carbon powder has both properties of the graphite powder derived from the carbide and the graphite powder derived from the carbon material. When the graphite-containing carbon powder is used as an electrode active material for a secondary battery, it is desirable to use easily-graphitizable carbon such as coke as a carbon material from the viewpoint of capacity.

When coke is used as a carbon material, a calcined coke or a green coke (coke as it is taken out from the coking device) can be used. As a raw material of the coke, for example, petroleum pitch, coal pitch, and a mixture thereof can be used. Particularly preferred is a calcined coke obtained by further heating the green coke under an inert atmosphere, wherein the green coke is obtained by the delayed coking treatment under specific conditions.

Examples of raw materials to be subjected to delayed coking treatment include decant oil which is obtained by removing a catalyst after the process of fluidized-bed catalytic cracking of heavy distillate at the time of crude oil refining, and tar obtained by distilling coal tar extracted from bituminous coal and the like at a temperature of 200° C. or more and heating it to 100° C. or more to impart sufficient flowability. It is desirable that these liquids are heated to 450° C. or more, or even 510° C. or more, during the delayed coking treatment, at least at an inlet of the coking drum. By heating the materials to 450° C. or more, the residual carbon ratio of the coke at the time of calcination is increased. The calcination means performing heating to remove moisture and organic volatile components contained in the material such as green coke obtained by the delayed coking treatment. Also, pressure inside the drum is kept at preferably a normal pressure or higher, more preferably 300 kPa or higher, still more preferably 400 kPa or higher. Maintaining the pressure inside the drum at a normal pressure or higher, the capacity of a negative electrode is further increased.

As described above, by performing coking treatment under more severe conditions than usual, the raw materials in the form of a liquid such as decant oil are reacted and coke having a higher degree of polymerization can be obtained.

The calcination can be performed by electric heating and flame heating using LPG, LNG, korosene, heavy oil and the like. Since the heating at 2,000° C. or less is sufficient to remove moisture and organic volatile components, flame heating as an inexpensive heat source is preferable for mass production. When the treatment is particularly performed on a large scale, energy cost can be reduced by an inner-flame or inner-heating type heating of coke while burning fuel and the organic compound contained in the unheated coke in a rotary kiln.

The obtained coke is to be cut out from the drum by water jetting, and roughly pulverized to lumps about the size of 5 cm. Not only a hammer but also a double roll crusher and a jaw crusher can be used for the rough pulverization. It is desirable to perform the rough pulverization of coke so that when the aggregates after the rough pulverization are sift through a sieve with a mesh having a side length of 1 mm, the aggregates remained on the sieve account for 90 mass % or more of the total aggregates. If the coke is pulverized too much to generate a large amount of fine powder having a diameter of 1 mm or less, problems such as the dust stirred up after drying and the increase in burnouts may arise in the subsequent processes such as heating.

There is no limitation for the method of fine pulverization of a carbon powder, and it can be conducted using a known jet mill, hammer mill, roller mill, pin mill, vibration mill or the like.

It is desirable to perform fine pulverization so that coke has a 50% particle diameter in a volume-based cumulative particle size distribution by laser diffraction method, D₅₀ (median diameter), of from 1 μm to 50 μm. To perform pulverization to make D₅₀ less than 1 μm, it requires use of a specific equipment and a large amount of energy. By setting D₅₀ to 50 μm or less, it facilitates mixing of the pulverized coke with a silicon carbide powder. D₅₀ is more preferably from 5 μm to 35 μm.

The production method of the present invention comprises a process of performing heat treatment of the carbon-coated raw material. When a carbon-coated raw material is obtained by mixing a carbide and a carbon coating material by a dry method, a uniform film of the coating material fails to be formed in some cases. However, the coating material is softened and spread over the surface of the carbide particles and thus becomes a uniform coating. By further heat treatment, a carbide contained in the carbon-coated raw material is thermally decomposed to thereby generate graphite.

The mixing of the carbide and a carbon material that serves as a fusion inhibitor of the carbide particles is performed prior to heat treatment. The heat treatment time is, for example, preferably from about 10 minutes to about 100 hours. A suitable heat treatment temperature depends on a kind of a carbide. For example, when silicon carbide is used as a carbide, the heat treatment temperature is preferably 2,200° C. or higher, more preferably 2,500° C. or higher, still more preferably 3,000° C., most preferably 3,150° C. or higher. The treatment at a higher temperature promotes the development of the graphite crystals, and an electrode having a higher storage capacity of lithium ions can be obtained. Also, the concentrations of elements other than carbon derived from a carbide decreases by the treatment at a higher temperature, thereby increasing the purity of the obtained graphite-containing carbon powder.

On the other hand, if the temperature is too high, it is difficult to prevent the sublimation of carbon and an unduly large amount of energy for elevating the temperature is required. Therefore, the graphitization temperature is preferably 3,600° C. or lower. In order to achieve a temperature for heat treatment, heating by energization is preferable.

In an embodiment of the present invention, it is desirable to subject the graphite-containing carbon powder to sieving treatment to remove a coarse powder. By removing a coarse powder, a stable electrode quality is attained when the graphite-containing carbon powder is used as an active substance of an electrode for a secondary battery and good battery properties can be obtained. There is no limit for the mesh size of a sieve, and a sieve having an arbitrary mesh size can be used depending on purposes. When the undersize yield of the graphite-containing carbon powder after the heat treatment is high, a yield of the graphite-containing carbon powder in one process increases to thereby reduce the production cost. According to the method of the present invention, the undersize yield of the graphite-containing carbon powder obtained by the heat treatment process can be increased.

In the present invention, when the graphite-containing carbon powder obtained by heat treatment is classified with a sieve, the undersize yield indicates the ratio of the mass of the graphite-containing carbon powder that passed through the mesh of a sieve to the mass of the graphite-containing carbon powder prior to the sieving treatment (mass of the graphite-containing carbon powder that passed through the sieve mesh/mass of the graphite-containing carbon powder prior to the sieving treatment).

(2) Graphite Powder for an Electrode (Negative Electrode) of a Lithium Ion Secondary Battery

The graphite powder in an embodiment of the present invention has an average interplanar spacing of the (002) planes by the X-ray diffraction method (d₀₀₂) of 0.3370 nm or less; and a thickness (L_{c}) of the crystallite in the c-axis direction of preferably 50 nm or more. By using a carbon powder having d₀₀₂ and L_{c} values in the above-mentioned range, a discharge capacity per mass of the electrode using the graphite-containing carbon powder as an active material increases and the electrode density by pressing is improved. When d₀₀₂ exceeds 0.3370 nm or L_{c} is less than 50 nm, a discharge capacity per volume is apt to decrease. In a more preferred embodiment, d₀₀₂ is 0.336 nm or less and L_{c} is 80 nm or more.

d₀₀₂ and L_{c} can be measured by a known method using a powder X-ray diffraction (XRD) method by a known method (see I. Noda and M. Inagaki, Japan Society for the Promotion of Science, 117th Committee material, 117-71-A-1 (1963), M. Inagaki et al., Japan Society for the Promotion of Science, 117th committee material, 117-121-C-5 (1972), M. Inagaki, “carbon”, 1963, No. 36, pages 25-34.

The graphite-containing carbon powder in an embodiment of the present invention has a suitable particle size distribution, pulverization after heat treatment which may cause lattice defects is not needed. Therefore, most of the hexagonal structures are maintained in the obtained graphite-containing carbon powder, and the graphite-containing carbon powder has a ratio of the peak intensity derived from rhombohedral structures to the peak intensity derived from hexagonal structures of preferably 0.05 or less, more preferably 0.02 or less.

In the case of using a graphite powder having a ratio of the peak intensity derived from rhombohedral structures of 0.05 or less as a negative electrode material in a lithium ion secondary battery, the lithium occlusion/release reaction is hardly inhibited, which enhances cycle characteristics and rapid charging/discharging characteristics. For example, in a coin cell composed of a work electrode using a graphite powder of the present invention as an active material, a lithium metal counter electrode, a separator and an electrolyte, which work electrode has been manufactured by a method comprising a process of compressing the graphite powder at a predetermined pressure, it is possible to attain a capacity retention rate after 100 cycles of 95% or higher.

It should be noted that the ratio x of the peak intensity derived from rhombohedral structures to the peak intensity derived from hexagonal structures in a graphite powder can be calculated by the following formula.

x=P1/P2

In the formula, P1 represents the peak intensity of a rhombohedral structure (101) plane and P2 represents the peak intensity of a hexagonal structure (101) plane.

The graphite-containing carbon powder in an embodiment of the present invention preferably has a median diameter in a volume-based cumulative particle size distribution by laser diffraction method, D₅₀, of 1 to 50 μm. By setting D₅₀ to 50 μm or less, lithium ion diffusion in an electrode made from the powder is accelerated, resulting in the increase in the charging and discharging rate. D₅₀ is more preferably 5 to 40 μm, still more preferably 10 to 30 μm. By setting D₅₀ to 10 μm or more is more preferable because an unintended reaction becomes hard to occur. From the viewpoint that generation of a large current is necessary for the carbon powder to be used in the driving power source for automobiles and the like, D₅₀ is preferably 30 μm or less.

In an embodiment of the present invention, the BET specific surface area of the graphite-containing carbon powder for a negative electrode material for a lithium ion secondary battery is preferably 0.4 m²/g to 15 m²/g, more preferably 1.0 m²/g to 11.0 m²/g. By setting the BET specific surface area to be within a range of 0.4 m²/g to 15.0 m²/g, a wide area to be contacted with an electrolytic solution can be secured without excessive use of a binder and lithium ions can be smoothly inserted and de-inserted, and the rapid charge and discharge characteristics can be improved with lowering the reaction resistance of the battery. The BET specific surface area is measured by a common method of measuring adsorption and desorption amount of gas per unit mass. As a measuring device, for example, NOVA-1200 manufactured by Yuasa Ionics can be used, and the BET specific surface area can be measured by nitrogen-gas molecule adsorption.

The graphite-containing carbon powder in an embodiment of the present invention has a powder density (tap density) when tapping is performed 400 times of preferably 0.7 g/cm³ or more, more preferably 0.8 g/cm³ or more, still more preferably 0.9 g/cm³ or more. The tap density is a value measured by a method described in Examples.

By setting the tap density to be 0.7 g/cm³ or more, it is possible to reduce the occupied volume of the graphite-containing carbon powder at the time of storage and transportation to thereby reduce the cost in industrial use.

(3) Carbon Material for Battery Electrodes

The carbon material for battery electrodes in an embodiment of the present invention contains the above-mentioned graphite-containing carbon powder. By using the graphite-containing carbon powder as a carbon material for an battery electrode, a battery electrode having a high energy density can be obtained, while maintaining a high capacity, a high coulomb efficiency and high cycle characteristics.

The uses as a carbon material for a battery electrode include, for example, a negative electrode active material and an agent for imparting conductivity to a negative electrode of a lithium ion secondary battery.

The carbon material for battery electrodes in an embodiment of the present invention may comprise the above-mentioned graphite-containing carbon powder only. It is also possible to use the materials obtained by blending spherical natural graphite or artificial graphite such as mesophase artificial graphite in an amount of 0.01 to 200 parts by mass and preferably 0.01 to 100 parts by mass; or by blending natural or artificial graphite (for example, flake graphite) having d₀₀₂ of 0.3370 nm or less and aspect ratio of 2 to 100 in an amount of 0.01 to 120 parts by mass and preferably 0.01 to 100 parts by mass based on 100 parts by mass of the above-mentioned graphite-containing carbon powder. By using the graphite-containing carbon powder mixed with other carbon materials for a battery electrode, the graphite material can be added with excellent properties of other graphite materials while maintaining the excellent characteristics of the graphite-containing carbon powder of the present invention. With respect to mixing of these materials, the material to be mixed can be selected and its mixing ratio can be determined appropriately depending on the required battery characteristics.

Carbon fiber may also be mixed with the carbon material for battery electrodes. The mixing amount is 0.01 to 20 parts by mass, preferably 0.5 to 5 parts by mass in terms of 100 parts by mass of the above-mentioned graphite-containing carbon powder.

Examples of the carbon fiber include: organic-derived carbon fiber such as PAN-based carbon fiber, pitch-based carbon fiber, and rayon-based carbon fiber; and vapor-grown carbon fiber. Of those, in the case of allowing the carbon fiber to adhere to the surfaces of the graphite-containing carbon powder, particularly preferred is vapor-grown carbon fiber having high crystallinity and high heat conductivity.

Vapor-grown carbon fiber is, for example, produced by: using an organic compound as a raw material; introducing an organic transition metal compound as a catalyst into a high-temperature reaction furnace with a carrier gas; and then conducting heat treatment (see, for example, JP S62-49363 B and JP 2778434 B2). The vapor-grown carbon fiber has a fiber diameter of 2 to 1,000 nm, preferably 10 to 500 nm, and has an aspect ratio of preferably 10 to 15,000.

Examples of the organic compound serving as a raw material for carbon fiber include gas of toluene, benzene, naphthalene, ethylene, acetylene, ethane, natural gas, carbon monoxide or the like, and a mixture thereof. Of those, an aromatic hydrocarbon such as toluene or benzene is preferred.

The organic transition metal compound includes a transition metal element serving as a catalyst. Examples of the transition metal element include metals of Groups III to XI of the periodic table. Preferred examples of the organic transition metal compound include compounds such as ferrocene and nickelocene.

The carbon fiber may be obtained by pulverizing or disintegrating long fiber obtained by vapor deposition or the like. Further, the carbon fiber may be agglomerated in a flock-like manner.

Carbon fiber which has no pyrolysate derived from an organic compound or the like adhering to the surface thereof or carbon fiber which has a carbon structure with high crystallinity is preferred.

The carbon fiber with no pyrolysate adhering thereto or the carbon fiber having a carbon structure with high crystallinity can be obtained, for example, by firing (heat-treating) carbon fiber, preferably, vapor-grown carbon fiber in an inactive gas atmosphere. Specifically, the carbon fiber with no pyrolysate adhering thereto is obtained by heat treatment in inactive gas such as argon at about 800° C. to 1,500° C. Further, the carbon fiber having a carbon structure with high crystallinity is obtained by heat treatment in inactive gas such as argon preferably at 2,000° C. or more, more preferably 2,000° C. to 3,000° C.

It is preferred that the carbon fiber contains a branched fiber. Further, in the branched portions, the carbon fiber may have hollow structures communicated with each other. In the case where the carbon fiber has hollow structures, carbon layers forming a cylindrical portion of the fiber are formed continuously. The hollow structure in carbon fiber refers to a structure in which a carbon layer is wound in a cylindrical shape and includes an incomplete cylindrical structure, a structure having a partially cut part, two stacked carbon layers connected into one layer, and the like. Further, the cross-section is not limited to a complete circular shape, and the cross-section of the cylinder includes a near-oval or near-polygonal shape.

Further, the average interplanar spacing of the (002) planes by the X-ray diffraction method, d₀₀₂, is preferably 0.3440 nm or less, more preferably 0.3390 nm or less, particularly preferably 0.3380 nm or less. Further, it is preferred that a thickness in a c-axis direction of crystallite (L_{c}) is 40 nm or less.

When a carbon material for electrodes contain graphite or carbon fiber other than the above-mentioned graphite-containing carbon powder, it is desirable that the electrode density of the carbon material for electrodes falls within the range noted for the above-described graphite-containing carbon powder.

(4) Paste for Electrodes

A paste for an electrode can be produced from the carbon material for battery electrodes of the present invention and a binder. The paste for an electrode can be obtained by kneading the carbon material for electrodes with a binder. A known device such as a ribbon mixer, a screw-type kneader, a Spartan granulator, a Loedige mixer, a planetary mixer, or a universal mixer may be used for kneading. The paste for an electrode may be formed into a sheet shape, a pellet shape, or the like.

Examples of the binder to be used for the paste for an electrode include known binders such as: fluorine-based polymers such as polyvinylidene fluoride and polytetrafluoroethylene; and rubber-based polymers such as styrene-butadiene rubber (SBR).

The appropriate use amount of the binder is 1 to 30 parts by mass in terms of 100 parts by mass of the carbon material for a battery electrode, and in particular, the use amount is preferably about 3 to 20 parts by mass.

A solvent can be used at a time of kneading. Examples of the solvent include known solvents suitable for the respective binders such as: toluene and N-methylpyrrolidone in the case of a fluorine-based polymer; water in the case of rubber-based polymers; dimethylformamide and 2-propanol in the case of the other binders. In the case of using the binder employing water as a solvent, it is preferred to use a thickener together. The amount of the solvent is adjusted so as to obtain a viscosity at which a paste can be applied to a current collector easily.

(5) Electrode

An electrode in an embodiment of the present invention comprises a formed body of the above-mentioned paste for an electrode. The electrode is obtained, for example, by applying the above-mentioned paste for an electrode to a current collector, followed by drying and pressure forming.

Examples of the current collector include metal foils and mesh of aluminum, nickel, copper, stainless steel and the like. The coating thickness of the paste is generally 50 to 200 μm. When the coating thickness becomes too large, a negative electrode may not be accommodated in a standardized battery container. There is no particular limitation for the paste coating method, and an example of the coating method includes a method of coating with a doctor blade, a bar coater or the like, followed by forming by roll pressing or the like.

Examples of the pressure forming include roll pressurization, plate pressurization, and the like. The pressure for the pressure forming is preferably 49 to 490 MPa, more preferably 98 to 392 MPa, still more preferably 147 to 294 MPa. As the electrode density of the electrode increases, the battery capacity per volume generally increases. However, if the electrode density is increased too much, the carbon material for electrodes is damaged and the cycle characteristic is degraded. The maximum value of the electrode density of the electrode obtained using the paste is generally 1.5 to 1.9 g/cm³. The electrode thus obtained is suitable for a negative electrode of a battery, in particular, a negative electrode of a secondary battery.

(6) Battery

The above-described electrode can be employed as an electrode in a battery or a secondary battery.

The battery or secondary battery in an embodiment of the present invention is described by taking a lithium ion secondary battery as a specific example. The lithium ion secondary battery has a structure in which a positive electrode and a negative electrode are soaked in an electrolytic solution or an electrolyte. As the negative electrode, the electrode in an embodiment of the present invention is used.

In the positive electrode of the lithium ion secondary battery, a transition metal oxide containing lithium is generally used as a positive electrode active material, and preferably, an oxide mainly containing lithium and at least one kind of transition metal element selected from the group consisting of Ti, V, Cr, Mn, Fe, Co, Ni, Mo, and W, which is a compound having a molar ratio of lithium to a transition metal element of 0.3 to 2.2, is used. More preferably, an oxide mainly containing lithium and at least one kind of transition metal element selected from the group consisting of V, Cr, Mn, Fe, Co and Ni.

It should be noted that Al, Ga, In, Ge, Sn, Pb, Sb, Bi, Si, P, B, and the like may be contained in a range of less than 30% by mole with respect to the mainly present transition metal. Of the above-mentioned positive electrode active materials, it is preferred that at least one kind of material represented by a general formula LiₓMO₂ (M represents at least one kind of Co, Ni, Fe, and Mn, and x is 0.02 to 1.20), or material having a spinel structure represented by a general formula Li_{y}N₂O₄ (N contains at least Mn, and y is 0.02 to 2.00) be used.

Further, as the positive electrode active material, there may be particularly preferably used at least one kind of materials each including Li_{y}MₐD₁₋ₐO₂ (M represents at least one kind of Co, Ni, Fe, and Mn, D represents at least one kind of Co, Ni, Fe, Mn, Al, Zn, Cu, Mo, Ag, W, Ga, In, Sn, Pb, Sb, Sr, B, and P with the proviso that the element corresponding to M being excluded, y=0.02 to 1.20, and a=0.50 to 1.00) or materials each having a spinel structure represented by Li_{z}(Mn_{b}E_{1-b})₂O₄ (E represents at least one kind of Co, Ni, Fe, Al, Zn, Cu, Mo, Ag, W, Ga, In, Sn, Pb, Sb, Sr, B and P, b=1.00 to 0.20, and z=0 to 2.00).

Specifically, there are exemplified LiₓCoO₂, LiₓNiO₂, LiₓFeO₂, LiₓMnO₂, LiₓCoₐNi₁₋ₐO₂, LiₓCo_{b}V_{1-b}O₂, LiₓCo_{b}Fe_{1-b}O₂, LiₓMn₂O₄, LiₓMn₀Co_{2-c}O₄, LiₓMn₀Ni_{2-c}O₄, LiₓMn_{c}V_{2-c}O₄, and LiₓMn_{c}Fe_{2-c}O₄ (where, x=0.02 to 1.20, a=0.10 to 0.90, b=0.80 to 0.98, c=1.60 to 1.96, and z=2.01 to 2.30). As the more preferred transition metal oxide containing lithium, there are given LiₓCoO₂, LiₓNiO₂, LiₓFeO₂, LiₓMnO₂, LiₓCoₐNi₁₋ₐO₂, LiₓMn₂O₄, and LiₓCo_{b}V_{1-b}O_{z} (x=0.02 to 1.20, a=0.10 to 0.90, b=0.90 to 0.98, and z=2.01 to 2.30). It should be noted that the value of x is a value before starting charge and discharge, and the value increases and decreases in accordance with charge and discharge.

Although the median diameter, D₅₀, of the positive electrode active material is not particularly limited, the diameter is preferably 0.1 to 50 μm. It is preferred that the volume occupied by the particle group having a particle diameter of 0.5 to 30 μm be 95% or more of the total volume. It is more preferred that the volume occupied by the particle group having a particle diameter of 3 μm or less be 18% or less of the total volume, and the volume occupied by the particle group having a particle diameter of 15 μm to 25 μm be 18% or less of the total volume. The average particle diameter value can be measured using a laser diffraction particle size distribution analyzer, such as Mastersizer produced by Malvern Instruments Ltd.

Although the specific area of the positive electrode active material is not particularly limited, the area is preferably 0.01 to 50 m²/g, particularly preferably 0.2 m²/g to 1 m²/g by a BET method. Further, it is preferred that the pH of a supernatant obtained when 5 g of the positive electrode active material is dissolved in 100 ml of distilled water be 7 to 12.

In a lithium ion secondary battery, a separator may be provided between a positive electrode and a negative electrode. Examples of the separator include non-woven fabric, cloth, and a microporous film each mainly containing polyolefin such as polyethylene and polypropylene, a combination thereof, and the like.

As an electrolytic solution and an electrolyte forming the lithium ion secondary battery in a preferred embodiment of the present invention, a known organic electrolytic solution, inorganic solid electrolyte, and polymer solid electrolyte may be used, but an organic electrolytic solution is preferred in terms of electric conductivity.

As an organic electrolytic solution, preferred is a solution of an organic solvent such as: an ether such as dioxolan, diethyl ether, dibutyl ether, ethylene glycol monomethyl ether, ethylene glycol monoethyl ether, ethylene glycol monobutyl ether, diethylene glycol monomethyl ether, diethylene glycol monoethyl ether, diethylene glycol monobutyl ether, diethylene glycol dimethyl ether, ethylene glycol phenyl ether, or diethoxyethane; an amide such as formamide, N-methylformamide, N,N-dimethylformamide, N-ethylformamide, N,N-diethylformamide, N-methylacetamide, N,N-dimethylacetamide, N-ethylacetamide, N,N-diethylacetamide, N,N-dimethylpropionamide, or hexamethylphosphorylamide; a sulfur-containing compound such as dimethylsulfoxide or sulfolane; a dialkyl ketone such as methyl ethyl ketone or methyl isobutyl ketone; a cyclic ether such as ethylene oxide, propylene oxide, tetrahydrofuran, 2-methoxytetrahydrofuran, 1,2-dimethoxyethane, or 1,3-dioxolan; a carbonate such as ethylene carbonate, butylene carbonate, diethyl carbonate, dimethyl carbonate, propylene carbonate, or vinylene carbonate; γ-butyrolactone; N-methylpyrrolidone; acetonitrile; nitromethane; or the like. There are more preferably exemplified: esters such as ethylene carbonate, butylene carbonate, diethyl carbonate, dimethyl carbonate, propylene carbonate, vinylene carbonate, or γ-butyrolactone; ethers such as dioxolan, diethyl ether, or diethoxyethane; dimethylsulfoxide; acetonitrile; tetrahydrofuran; or the like. A carbonate-based nonaqueous solvent such as ethylene carbonate or propylene carbonate may be particularly preferably used. One kind of those solvents may be used alone, or two or more kinds thereof may be used as a mixture.

A lithium salt is used for a solute (electrolyte) of each of those solvents. Examples of a generally known lithium salt include LiClO₄, LiBF₄, LiPF₆, LiAlCl₄, LiSbF₆, LiSCN, LiCl, LiCF₃SO₃, LiCF₃CO₂, LiN(CF₃SO₂)₂, and the like.

Examples of the polymer solid electrolyte include a polyethylene oxide derivative and a polymer containing the derivative, a polypropylene oxide derivative and a polymer containing the derivative, a phosphoric acid ester polymer, a polycarbonate derivative and a polymer containing the derivative, and the like.

It should be noted that there is no constraint for the selection of members required for the battery configuration other than the aforementioned members.

### EXAMPLES

Hereinafter, the present invention is described in more detail by way of typical examples. It should be noted that these examples are merely for illustrative purposes, and the present invention is not limited thereto.

It should be noted that, as for the graphite-containing carbon powder obtained in Examples and Comparative Examples, the methods for measuring an underscore yield, a particle diameter and a tap density are given below.

(1) Measurement Method of Undersize Yield

A dry-method sieving treatment was conducted for the purpose of removing a coarse powder from the graphite-containing carbon powder and calculating an undersize yield. A stainless-steel sieve according to JIS 28801 having a wire diameter of 32 μm and a mesh size of 45 μm was used. The graphite-containing carbon powder was sifted for 10 minutes using an automatic vibration sifter (VSS-50) manufactured by Tsutsui Scientific Instruments Co., Ltd. The ratio of the mass of the carbon powder that passed through the mesh of a sieve to the mass of the carbon powder prior to the sieving treatment (mass of the carbon powder that passed through the sieve mesh/mass of the carbon powder prior to the sieving treatment) was calculated and the value was designated as an undersize yield.

(2) Measurement Method of the Particle Diameter (D₁₀, D₅₀ and D₉₀)

The volume-based 10% particle diameter (D₁₀), median diameter (D₅₀), and 90% particle diameter (D₉₀) were determined by using Mastersizer (registered trademark) produced by Malvern Instruments Ltd. as a laser-diffraction particle size distribution analyzer.

(3) Measurement Method of Tap Density

The tap density is obtained by measuring the volume and mass of 100 g of powder tapped 400 times using an Autotap produced by Quantachrome Instruments. These methods are based on ASTM B527 and JIS K5101-12-2, and the fall height of the Autotap in the tap density measurement is 5 mm.

### Example 1

After pulverizing Chinese-made silicon carbide produced in an Acheson furnace and having a purity of 95% with a rod mill, a coarse powder was removed using a sieve having a mesh of 32 μm to thereby obtain silicon carbide powder 1. 100 parts by mass of the silicon carbide powder 1 and 2 parts by mass of petroleum-based pitch containing 73 mass % of fixed carbon were loaded into a planetary and centrifugal mixer, and a dry blending was performed at 2,000 rpm for 20 minutes to obtain carbon-coated raw material 1. Here, the carbon coated on the surface of the silicon carbide is calculated to be 1.5 parts by mass with respect to 100 parts by mass of silicon carbide from the mass of the fixed carbon contained in the petroleum-based pitch.

On the other hand, Chinese-made calcined coke was pulverized with a bantam mill produced by Hosokawa Micron Corporation and subsequently coarse powder was excluded with a sieve having a mesh size of 32 μm. Next, the pulverized coke is subjected to air-flow classification with Turboclassifier (TC-15N) produced by Nisshin Engineering Inc. to obtain carbon material 1 having D₅₀ of 17 μm, substantially containing no particles each having a particle diameter of 1.0 μm or less. (Here, the state where the carbon material substantially contains no particles having a diameter of 1.0 μm or less indicates that the particles having a particle diameter of 1.0 μm or less account for 0.1 vol % or less).

The carbon-coated raw material 1 and the carbon material 1 were mixed for 30 minutes using a V-shape mixer (S-5 type; manufactured by Tsutsui Scientific Instruments Co., Ltd.) to obtain a mixed raw material 1. At the time of mixing, mixing was performed so that the content of the carbon-coated raw material 1 with respect to the entirety of the mixed raw material 1 (mass of the carbon-coated raw material 1/total of mass of the carbon coated raw material 1 and the mass of carbon material 1) becomes 20.0 mass %. The mixed raw material 1 was put in a crucible and heat treatment of the mixture was conducted by using an Acheson furnace so as to adjust a maximum reached temperature to 3,300° C. The undersize yield, the median diameter and the tap density of the obtained graphite-containing carbon powder were measured. Table 1 shows the results.

### Example 2

Example 2 was conducted in the same way as Example 1 except that the addition amount of the petroleum-based pitch containing 73 mass % of fixed carbon was 7 parts by mass at the time of dry blending to obtain a carbon-coated raw material. In this case, the carbon coated on the surface of the silicon carbide is calculated to be 5.1 parts by mass with respect to 100 parts by mass of silicon carbide. Table 1 shows the results.

### Example 3

Example 3 was conducted in the same way as Example 1 except that at the time of mixing the carbon-coated raw material 1 and the carbon material 1 were mixed to obtain a mixed raw material, the blending was conducted so that the content of the carbon-coated raw material 1 with respect to the total of the mixed raw material becomes 30.0 mass %. Table 1 shows the results.

### Example 4

Example 4 was conducted in the same way as Example 3 except that the addition amount of the petroleum-based pitch containing 73 mass % of fixed carbon was 7 parts by mass at the time of dry blending to obtain a carbon-coated raw material. In this case, the carbon coated on the surface of the silicon carbide is calculated to be 5.1 parts by mass with respect to 100 parts by mass of silicon carbide. Table 1 shows the results.

### Comparative Example 1

After pulverizing the silicon carbide used in Example 1 with a rod mill, coarse powder was excluded by using a sieve having a mesh size of 32 μm to obtain silicon carbide powder 1.

On the other hand, the calcined coke used in Example 1 was pulverized with a bantam mill produced by Hosokawa Micron Corporation and subsequently coarse powder was excluded with a sieve having a mesh size of 32 μm. Next, the pulverized coke was subjected to air-flow classification with Turboclassifier (TC-15N) produced by Nisshin Engineering Inc. to obtain carbon material 1 having D₅₀ of 17 μm, substantially containing no particles each having a particle diameter of 1.0 μm or less.

The silicon carbide powder 1 and the carbon material 1 were mixed for 30 minutes using a V-shape mixer (S-5 type; manufactured by Tsutsui Scientific Instruments Co., Ltd.) to obtain a mixed raw material 2. At the time of mixing, mixing was performed so that the content of the silicon carbide powder 1 with respect to the entirety of the mixed raw material 2 becomes 20.0 mass %. The mixed raw material 2 was put in a crucible and heat treatment of the mixture was conducted by using an Acheson furnace so as to adjust a maximum reached temperature to 3,300° C. The undersize yield, the median diameter after excluding coarse powder and the tap density of the obtained graphite-containing carbon powder were measured. Table 1 shows the results.

TABLE 1

| | Raw material | | | | |
|---|---|---|---|---|---|
| | Content of carbon | Content of carbon- | | | |
| | coating to 100 parts by | coated raw material | Graphite-containing carbon powder | | |
| | mass of silicon | in the mixed raw | Undersize | Median | |
| | carbide | material | yield | diameter | Tap density |
| | (parts by mass) | (mass %) | (%) | (μm) | (g/cm³) |
| Example 1 | 1.5 | 20.0 | 76 | 20 | 0.83 |
| Example 2 | 5.1 | 20.0 | 93 | 18 | 0.90 |
| Example 3 | 1.5 | 20.0 | 74 | 22 | 0.64 |
| Example 4 | 5.1 | 20.0 | 75 | 19 | 0.76 |
| Comparative | 0 | 20.0 | 44 | 21 | 0.75 |
| Example 1 | | | | | |

In the graphite-containing carbon powder obtained by the method of the present invention (Examples 1 to 4), the undersize yield is improved compared to the carbon powder obtained without forming a carbon coating on the silicon carbide (Comparative Example 1). In view of this, it is suggested that the carbon coating prevented the fusion of silicon carbide at the time of heat treatment, and as a result, contributed to the improvement of the undersize yield.

In addition, the presence of the carbon coating has an effect of improving the tap density of the carbon powder. In the carbon powder obtained by setting the content of the carbon-coated raw material in the mixed raw material to 20.0 mass % (Examples 1 and 2 and Comparative Example 1), the carbon powders of Examples 1 and 2, in which a carbon coating was formed on the silicon carbide, have a higher tap density. Due to a higher tap density, the cost at the time of storing and transporting the carbon powder can be reduced.

### INDUSTRIAL APPLICABILITY

The present invention provides a method for producing a graphite-containing carbon powder for a negative electrode of a lithium ion secondary battery having a high undersize yield and a high tapping density, which does not need pulverization treatment after heat treatment. The lithium ion secondary battery using the graphite-containing carbon powder for an electrode (negative electrode) of the present invention is small-sized and lightweight, and has a high discharge capacity and high cycle characteristics. Therefore, it can be suitably used for a wide range of products from mobile phones to electric tools, and even for a product that requires a high discharge capacity such as a hybrid automobile.

1. A method for producing a graphite-containing carbon powder for an electrode of a lithium ion secondary battery, comprising a process of forming a carbon coating on the surface of the carbide particles to obtain a carbon-coated raw material; a process of mixing the carbon-coated raw material and a carbon material to obtain a mixed raw material; and a heat treatment process of heating the mixed raw material to 2,000° C. or more to thermally decompose the carbide.

2. The method for producing a graphite-containing carbon powder for an electrode of a lithium ion secondary battery according to claim 1, wherein the carbide contains at least one member selected from silicon carbide, iron carbide, tungsten carbide, calcium carbide, aluminum carbide, molybdenum carbide, beryllium carbide, and nickel carbide.

3. The method for producing a graphite-containing carbon powder for an electrode of a lithium ion secondary battery according to claim 1, wherein the carbon coating comprises pitch or a polymer compound.

4. The method for producing a graphite-containing carbon powder for an electrode of a lithium ion secondary battery according to claim 1, wherein the carbon material is easily-graphitizable carbon.

5. The method for producing a graphite-containing carbon powder for an electrode of a lithium ion secondary battery according to claim 1, wherein the easily-graphitizable carbon contains at least one member of coke and coal.

6. The method for producing a graphite-containing carbon powder for an electrode of a lithium ion secondary battery according to claim 1, wherein a carbon coating content in the carbon-coated raw material is 0.5 part by mass to 20.0 parts by mass with respect to 100 parts by mass of the carbide particles.

7. The method for producing a graphite-containing carbon powder for an electrode of a lithium ion secondary battery according to claim 1, wherein the carbon-coated raw material and the carbon material are mixed so that the content of the carbon-coated raw material with respect to the mixed raw material obtained by mixing the carbon-coated raw material and the carbon material (mass of the carbon-coated raw material/total of the mass of the carbon-coated raw material and the mass of the carbon material) is 1.0 to 40.0 mass %.

8. A method for producing a graphite-containing carbon powder for an electrode of a lithium ion secondary battery, comprising a process of forming a carbon coating on the surface of the carbide particles to obtain a carbon-coated raw material; and a heat treatment process of heating the carbon-coated raw material to 2,000° C. or more to thermally decompose the carbide.

9. A carbon material for a battery electrode containing the graphite-containing carbon powder obtained by the production method according to claim 1.

10. The carbon material for a battery electrode according to claim 9, further comprising at least one member selected from natural graphite, artificial graphite and carbon fiber.

11. An electrode containing the carbon material for a battery electrode according to claim 9 which serves as at least part of an electrode active material.

12. A secondary battery comprising an electrode according to claim 11.
